(19) United States
(12) Patent Application Publication
(10) Pub. No.: US 2005/0079911 A1
(43) Pub. Date: Apr. 14, 2005

(54) Linked jackpot controller

(75) Inventor: Koji Nakatsu, Botany (AU)

Correspondence Address: KNOBBE MARTENS OLSON & BEAR LLP, 2040 MAIN STREET, FOURTEENTH FLOOR, IRVINE, CA, 92614, US

(73) Assignee: Konami Australia Pty Ltd, Botany (AU)

(21) Appl. No.: 10/496,750

(22) PCT Filed: Aug. 5, 2002
(86) PCT No.: PCT/AU02/01050

(30) Foreign Application Priority Data
Nov. 26, 2001 (AU) PR 9113

(51) Int. Cl. A63F 13/00

(52) U.S. Cl. 463/26

(57) ABSTRACT

A jackpot controller (10) including computing and display means (13, 14, 15) linked to an array of gaming consoles (12), the consoles (12) arranged to display selected first game features wherein randomized events are caused to award a prize if a predefined event occurs, the controller being characterized in that it is arranged to provide a second game feature.

The present invention relates to a system of interlinked gaming machines or consoles of the type generally referred to as slot machines, fruit machines or poker machines, and in particular to the combination of a plurality of such machines or consoles with a jackpot management means.

### BACKGROUND

Gaming or poker machines have become a major source of amusement and diversion in such places as clubs, hotels and casinos in many parts of the world.

Traditionally such machines were mechanical devices where a number of reels marked with a plurality of numbers or symbols could be made to spin randomly by the application of some mechanical input. If the subsequent patterns of numbers or symbols displayed on the reels, when these returned to a rest state, corresponded to predetermined patterns, the machine would provide a prize or payout. Generally such gaming machines have come to be regulated by government authorities as to their number and in the manner in which the machines must return a percentage of the money taken to the players.

The introduction of electronics, computers and video displays, has allowed a continual increase in the while maintaining the basic concept of the traditional machine.

Machines and games that offer novel and stimulating variations on the basic game theme and environment are eagerly sought by the gaming industry and there is consequently intense competition between machine manufacturers to innovate.

Nevertheless the repetitive playing of even modern gaming machines can lead to boredom of the players with a consequent under-utilization of machines and increase in player dissatisfaction. One perceived source of player boredom and alienation is the isolation of the player at his or her machine with little possibility of the stimulus of interaction with adjoining players.

It is an object of the present invention to offer a variation which may ameliorate the above disadvantages.

### BRIEF DESCRIPTION OF THE INVENTION

Accordingly, in one broad form of the invention there is provided a jackpot controller including computing and display means linked to an array of gaming consoles, the consoles arranged to display selected first game features wherein randomized events are caused to award a prize if a predefined event occurs, the controller being characterized in that it is arranged to provide a second game feature which awards a jackpot;

and wherein a pool increases incrementally by the current value of said jackpot whenever said jackpot is made available for winning by the second game feature but is not won.

Preferably said the jackpot controller includes a CPU, a memory device and input and output devices.

Preferably said display means includes a controller display screen, a jackpot display screen and a pool display screen.

Preferably said controller is adapted to accept input data from the array of consoles and is adapted to output data to the consoles.

Preferably the controller stores data generated by the progress of play on the linked gaming consoles.

Preferably the data collected by the controller includes the following data objects:

The elapsed time from program initiation or from the completion of the last second game feature whichever is the later.

The number and value of bets placed on each of the linked gaming consoles.

Preferably the controller display screen is used to inform players at the consoles about the second game feature.

Preferably the jackpot screen displays the type and amount of a prize comprising the jackpot.

Preferably the pool screen indicates the current amount, if any; of an accrued pool prize.

Preferably the second game feature is arranged to determine the winner of a jackpot or pool prize.

Preferably the jackpot may take a value which is constant.

Preferably the jackpot value may increase incrementally from a base value to a maximum value.

Preferably a second game feature may be triggered to occur according to any one of the following events:

A random time interval from a preceding second game feature, the time interval defined as lying between a minimum and a maximum value.

The value of a variable data object stored in the memory of the controller when this is equal to a pre-determined value.

The value of a variable calculated from the data objects stored in the memory of the controller according to an algorithm when the calculated value is equal to a pre-determined value.

Preferably the controller is arranged to select a number of players from the linked consoles as being eligible to play in the second game feature when this is triggered.

Preferably the selected eligible players have the option to elect to participate in said second game feature by indicating to the controller their willingness to participate in the second game feature.

Preferably a player selected by said controller as eligible to play said second game feature is automatically included in the play of said second game feature.

Preferably the second game -feature is a virtual horse race and wherein eligible players may be allocated a virtual horse by the controller.

Preferably the number of horses to run in the second game feature is always larger than the number of horses allocated to eligible players.

Preferably the winning horse in the virtual horse race is randomly determined.

Preferably if the winning horse in the race was allocated to a player, that player wins the jackpot prize and the pool prize.

In a further broad form of the invention there is provided a bank of gaming consoles in communication with the jackpot controller described above.

In yet a further broad form of the invention there is provided a gaming console in communication with the jackpot controller described above.

In yet a further broad form of the invention there is provided A gaming system for play by players playing a primary game on one or more gaming machines of a plurality of gaming machines; said plurality of gaming machines electronically linked into a bank of gaming machines; a secondary game controller in communication with each of said plurality of gaming machines forming said bank; said secondary game controller controlling a secondary game for which said players can be eligible to play; said secondary game awarding a jackpot; and wherein a pool increases incrementally by the current value of said jackpot whenever said jackpot is made available for winning by the second game feature but is not won.

Preferably said secondary game comprises a game viewable by all said players.

Preferably said secondary game awards both a prize and the contents of an accumulation prize pool if a play of said secondary game is won by an eligible player of at least one gaming machine on a play of said secondary game.

Preferably eligible players of said gaming machines for a play of said secondary game are selected by said secondary game controller.

Preferably a player can be selected more than once by said secondary game controller for a play of said secondary game.

Preferably a play of said secondary game is shown on a monitor associated with said secondary game controller.

Preferably a play of said secondary game is shown on a display associated with each gaming machine of said plurality of gaming machines.

Preferably a play of said secondary game is illustrated in animated form passing progressively from one to an adjacent one of said plurality of gaming machines.

In yet a further broad form of the invention there is provided in association with a bank of interconnected gaming machines, a secondary game feature which awards both a prize and the contents of an accumulation prize pool if a play of said secondary game feature is won by an eligible player of at least one gaming machine of said bank of interconnected gaming machines; and wherein the pool increases incrementally by the current value of the jackpot whenever the jackpot is made available for winning by the second game feature but is not won.

Preferably if said prize is not won on said play, then said prize is added to said accumulation prize pool.

Preferably eligibility of a player to participate in said secondary,game feature is independent of the outcome of a primary game feature running on any one of said gaming machines.

Preferably said secondary game feature is run by a secondary game controller running independently of any one of said interconnected gaming machines.

Preferably said secondary game controller determines eligibility of a player to participate in said secondary game feature.

### BRIEF DESCRIPTION OF THE DRAWINGS

Embodiments of the present invention will now be described with reference to the accompanying drawings wherein:

FIG. 1 is a perspective view of a generalized first embodiment of a linked jackpot controller for operation in association with a group of linked gaming machines;

FIG. 2 is a view of a first display of a second game feature operable in association with the system of FIG. 1;

FIG. 3 is an alternate view of the second game feature of FIG. 2 displayed via the displays forming part of the group of interlinked machines of FIG. 1;

FIG. 4 is a view of a display of player allocations in relation to the second game feature operable in conjunction with the system of FIG. 1;

FIG. 5 is a block diagram of operation of the linked jackpot controller according to an embodiment of the invention in relation to a first example;

FIG. 6 is a flow diagram of operation of qualification for the second game feature in accordance with the example of FIG. 5;

FIG. 7 is a flowchart of qualification for the second game feature of the example of FIG. 5 operable whilst the second game feature is already is operating;

FIG. 8 is a block diagram of a further generalized embodiment of a linked jackpot controller and associated bank of gaming machines;

FIG. 9 is a network interconnection diagram in accordance with a first particular example of the generalized embodiment of FIG. 8;

FIG. 10 is a network diagram of an alternative particular arrangement of the system of FIG. 8;

FIG. 11 is a third embodiment of a network interconnection arrangement for the generalized system of FIG. 8.

### DETAILED DESCRIPTION OF PREFERRED EMBODIMENTS

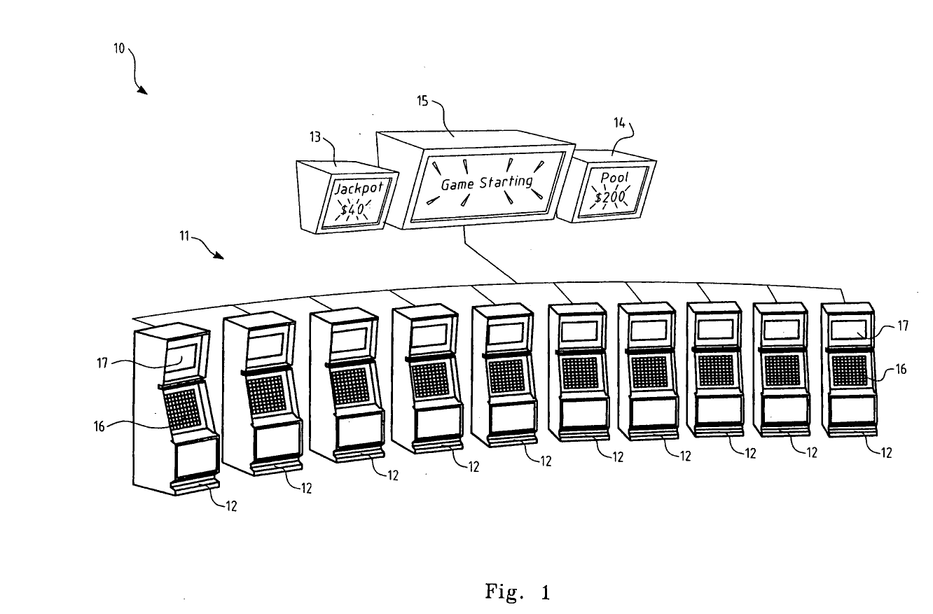

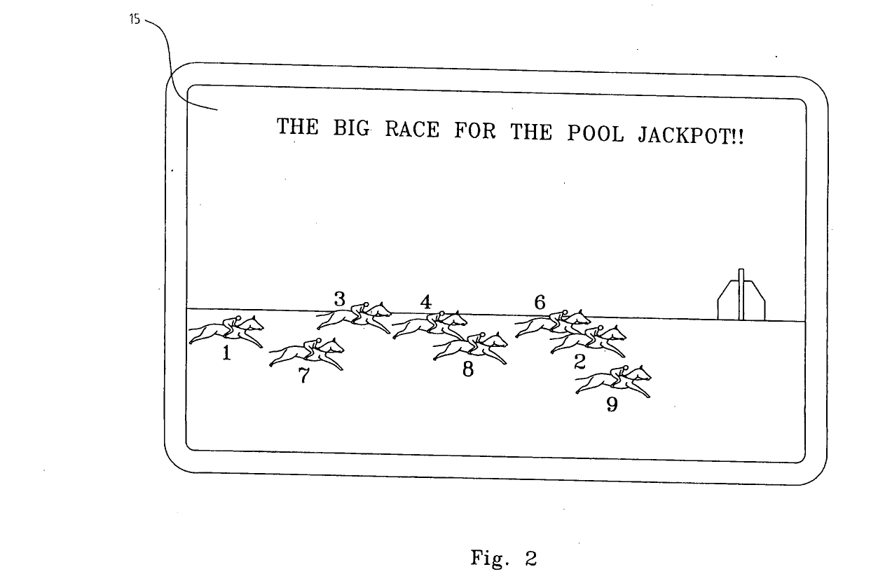

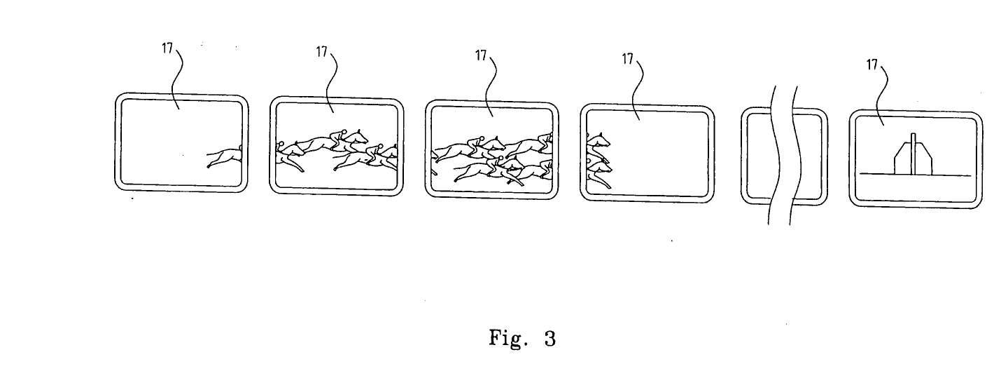

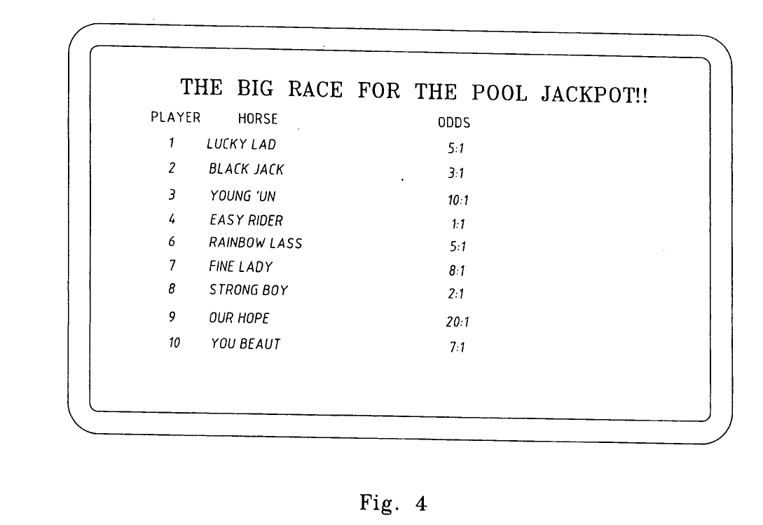

A generalized embodiment of a linked jackpot controller 10 of the present invention will now be described with reference to FIGS. 1 to 4, following which a series of non-limiting examples will be provided by way of further amplification.

With reference to FIG. 1, the system of embodiments of the present invention is applicable to a plurality, or bank 11, of gaming machines or consoles 12, generally disposed in a line or arc such that a player (not shown) at any one of the consoles 12 has a view of a centrally disposed jackpot controller 10. Each of the machines or consoles 12 in the bank 11 is connected to the jackpot controller 10 such that communication signals may pass between any one or all machines and the jackpot controller 10.

The jackpot controller 10 includes at least computing means and display means but may additionally be provided with audio output means and data entry means. The jackpot controller includes a CPU, a data storage and retrieval device and input and output devices.

The jackpot controller 10 is further linked to, and controls, two other display means: a “jackpot” display 13 and a “pool” display 14. The jackpot display 13 displays a jackpot prize which may be an amount of money, a number of free bonus games or some other form of prize. The pool screen may or may not display a prize initially, but will display an accumulation of jackpot prizes not won on a run of a secondary game feature controlled by the linked jackpot controller 10.

It is the object of the jackpot controller to provide a second game feature, (or “jackpot game”) which is additional to the individual games being played on the machines 12 in the bank 11.

A second game feature sequence will now be described with reference to the system illustrated in FIG. 1. Individual machines or consoles in the bank may be used in the normal manner by players who select to play any one from a plurality of standard games available on each console 12.

As bets are placed on a console, a percentage of the money deposited is transferred to the jackpot controller or otherwise made available for winnings associated with the outcome of the second game feature. In a particular form the jackpot controller 10 maintains a record of all data related to the bets and money accruing, including the console which generated the bet and the numbers of bets placed on each console by players.

The jackpot controller 10 is activated to initiate a second game feature depending on the occurrence of a predetermined event or sequence of events which may include one or more of:
1. A random event.
2. The statistically determined status of a data object within the jackpot controller.
3. The status of a combination of machines.
4. The coinciding of a value N of an incrementing counter with a randomly pre-selected hidden value M where both N and M lie in a range known to the players.

The triggering of a second game feature is indicated to the players currently playing on the bank of consoles and no new bets may be placed until the second game feature preparation is completed.

The second game feature may take a number of forms of “games of chance” such as roulette wheels, chocolate wheels and the like, but by way of example, the second game feature method here described is in the form of a horse race.

In preparing the game, the jackpot controller 10 determines the eligibility of players to participate in the race and displays this selection either on the jackpot controller display 15 or on displays on the individual machine consoles such as first display 16 or second display 17.

Those players who are indicated as eligible may agree to play the second game feature. They may indicate their participation by the depressing of a button on their consoles for example. Players who are selected as eligible but who do not indicate their intention to play may now continue with individual games on their console.

The jackpot controller 10 now assigns a horse to each of the participating players and runs the race comprising the second game feature in this instance. The race may be displayed on the jackpot controller display 15 or may be arranged to progress along the bank of individual console screens 16, 17 or both. Alternatively, or in addition, the race progress can be displayed in its entirety on each console screen 16, 17 of the participating players.

In this instance, the number of horses in the race is always greater than the number of eligible players. The race is run and the winning horse identified.

If the winning horse is one that was allocated to a participating player, a jackpot prize is issued by the jackpot controller 10 to that player. This may be done by directing the player's console to pay out the jackpot prize amount if this is money, or set the console to allow the free number of bonus games, or direct the player to collect his winnings in some other way.

If no participating player is assigned the winning horse, the jackpot prize amount is added by the jackpot controller 10 to the pool and the accumulated pool amount is displayed on the pool screen 14. The jackpot screen 13 remains at the constant jackpot amount or can be re-set to a minimum amount which subsequently accumulates itself in a predefined manner.

At the next triggering of a second game feature where the jackpot in the preceding game was not won, the race will be run for the jackpot prize amount and the pool amount. If this is won the pool screen display 14 returns to its default status showing a zero amount or some indication that the pool is empty.

The pool will continue to accrue jackpot prize amounts for as long as no horse allocated to a player wins a race comprising the second game feature.

The methods by which a second game feature may be triggered by the jackpot controller 10 and the method of selecting participants and the allocation of horses as well as possible means of disbursement of the prize will now be described in more detail.

Triggering of a Second Game Feature.

The following are possible, non-limiting ways of triggering the second game feature:
1. The jackpot controller includes a random number generating facility to generate a number within the range N to M. The second game feature is triggered when a selected parameter of the system reaches the generated random number. This parameter may be for example the accumulating value of all bets placed by all machines in the bank. The range N to M is chosen such that the probability of a triggering event occurring is at an average frequency to maintain the interest of the players at the consoles.
2. The second game feature is triggered when the jackpot controller calculates that the betting density has reached a predetermined level, that is, the average number N of all bets placed on all the consoles in the banks within a time period T exceeds a value X.
3. The second game feature is triggered when the jackpot controller detects that a sufficient number of machines in the bank have been in continuous use over a time period T.
4. The second game feature is triggered by an incrementing counter when the value of the count coincides with a randomly selected value. The counter is visible to the players and the minimum and maximum values are displayed. The randomly selected value is not known to the players but is known to lie between the minimum and maximum values of the counter.
   Selection of Eligible Players for the Second Game Feature.

The following are non-limiting ways in which players of the consoles comprising the bank of consoles may be selected as eligible to play the second game feature:
1. The jackpot controller may be programmed to select as eligible participants for the game, all of the currently occupied consoles.
2. The jackpot controller may be programmed to select as eligible participants for the game, those consoles which have placed a sufficient number of bets over a given period.
3. The jackpot controller may be programmed to select as eligible participants for the game, those consoles which have place bets to a sufficient value over a given time period.
4. The jackpot controller may be programmed to select as eligible participants for the game a random sub-set of the available players.
5. A participant may be qualified as eligible in accordance with the nature of the participant's bet in relation to the main or first game on the console or gaming machine that that person is currently playing.

In a particular form the bet can be, for example, a maximum line bet.

Allocation of Horses to Participating Players

To add realism to the game, the horses in the race may include identifiable “favorites” with this information displayed as starting odds for each horse on the jackpot controller screen. Although in the actual running of the race the winner will be randomly selected, the allocation of “favorites” will add further interest and excitement to the game.

The following are non-limiting ways in which available horses for a play of the second game feature may be allocated to players who have been selected as eligible to play the second game feature:
1. (a) The allocation of all horses by the jackpot controller to eligible participating players may be purely random.
   (b) In a particular form, a player may be allocated more than one available horse, while other eligible players may be allocated no horse.
2. The players may be allocated horses on the basis of horses with the shortest odds progressively matched to players with the highest betting record.
   Disbursement of Prizes Won in a Second Feature Game
1. The jackpot amount, or in the case of a pool having accumulated, the pool amount may be credited to the console of the winning player.
2. The jackpot or pool amount may be made payable modified by the use of the odds of the winning horse acting as a multiplier.

Specific but non-limiting examples of a linked jackpot controller for use in association with a plurality of linked gaming machines will now be provided.

### EXAMPLE 1

Linked Progressive Mystery Jackpot with Jackpot Pool System

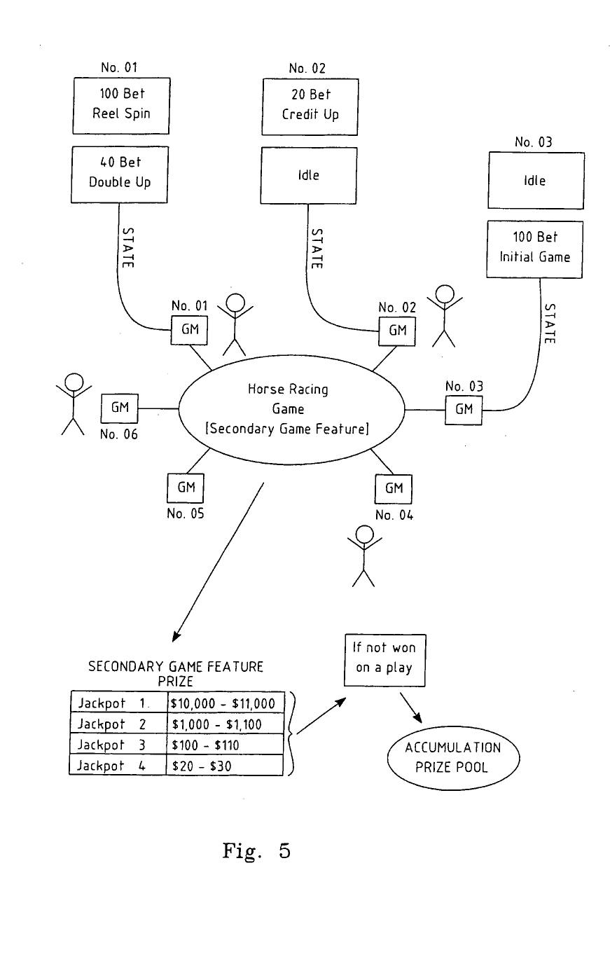

With reference to FIGS. 5, 6 and 7:

A horse racing game with 8 horses is linked to 6 poker machines. (It will be appreciated that the number of horses and poker machines can be varied whilst still remaining within the ambit and spirit of the game). Players participate in normal games run on each individual machine, as well as being able to win a special linked jackpot associated with the bank of machines.

In this example, there are 4 types of normal jackpots to be won. These 4 jackpots are set to be won between the following values;

| | |
|---|---|
| Jackpot 1 | $10,000-$11,000 |
| Jackpot 2 | $1,000-$1,100 |
| Jackpot 3 | $100-$110 |
| Jackpot 4 | $20-$30 |

The feature of this idea is that there is another accumulating jackpot or “Jackpot Pool”.

Whenever a normal jackpot is won, regardless of the type of jackpot, the player wins both the normal jackpot and the value of the Jackpot Pool. When no player has been selected to win a normal jackpot, the value of that jackpot is added to the Jackpot Pool.

The Jackpot Pool starts at a value of $0.

Each normal jackpot increases by $0.05 when a $1 bet is made on a machine linked to the horse racing game.

Example Play of Game including Second Game Feature

With reference to FIG. 5, of the 6 poker machines, machines No.01, No.02, No.04, No.06 have players participating while machines No.03 and No.05 have no players.

The player on machine No.01 triggers Jackpot 3. At present the value of Jackpot 3 is $110, and the Jackpot Pool has a value of $50. The player on No. 01 is assigned a horse. The other horses can be assigned to a maximum of 5 other players who were participating in a normal game when the player on No.01 triggered the normal jackpot.

Selection Process

In this instance, the selection process involves using a probability of 1/1200×Total Bet to elect players eligible to participate in the jackpot race.

Through software means or equivalent logic, the following steps determine eligibility (to prevent players waiting for just the jackpot race to trigger);

The current state of each machine is monitored, being selected from one of:

Idle

InitialGame

ReelSpin

ReelEvaluation

CreditUp

FreeGame

DoubleUp

GameOver

The selection process goes through each machine in order, determining if it will elect at maximum 5 (6-1) other players, continuing this process 10 times until ending.

The machine from where the selection process begins, is randomly selected from all the six machines regardless of it being in play or not.

The software determines that the selection process will begin from machine No.3.

Game states are shown below.

Selection Process begins from No.3, and continues 10 times.

| | | | | Win |
|---|---|---|---|---|
| Number | bet | game step | eligibility | probability |
| 4 | 100 | Initial Game | Yes | 100/1200 |
| 5 | — | Idle | No | 0 |
| 6 | 40 | Double Up | No | 0 |
| 1 | 100 | ReelSpin | Yes | 100/1200 |
| 2 | 20 | Credit Up | No | 0 |
| 3 | — | Idle | No | 0 |

The selection results are as follows;

| | |
|---|---|
| No. 01 | elected 2 times |
| No. 02 | elected 0 times |
| No. 03 | elected 0 times |
| No. 04 | elected 1 time |
| No. 05 | elected 0 times |
| No. 06 | elected 0 times |

Including the horse that the player on machine No.01 was assigned when the jackpot was triggered, the following has resulted
No.01 has been assigned 3 horses
No.04 has been assigned 1 horse Automatically, No.01 is given horses 1, 4 and 7, while No.04 is given 3. As it is an 8 horserace the other 4 horses, 2, 5, 6, 8 become the computer's horses.

The machines of players that have been selected to participate in the horse race are locked up, in the Top Box LCD or second display 17 (refer FIG. 1) the player's horse number is displayed. On the normal screen or first display 16 (refer FIG. 1) the horserace game title is displayed and no normal game play can be undertaken.

Players who weren't selected for the horse race can play normal games on their respective machines.

If a player who wasn't selected for the race comprising the second game feature continues playing while the race for Jackpot 3 is underway and that player triggers Jackpot 4, the same process as above occurs. The player's machines that have been selected lock up, and on the second display 17 a message saying “eligible for next race” is displayed.

The race starts and the machine with the winning horse wins both Jackpot 3 and the Jackpot Pool. If no machines have the winning horse Jackpot 3 is added to the Jackpot Pool, and the value of Jackpot 3 is re-set to its initial value.

In this example, horse number 8 won the race. As no machines were assigned that number the Jackpot Pool becomes $160 ($50+$110 ) and Jackpot 3 returns to initial value of $100.

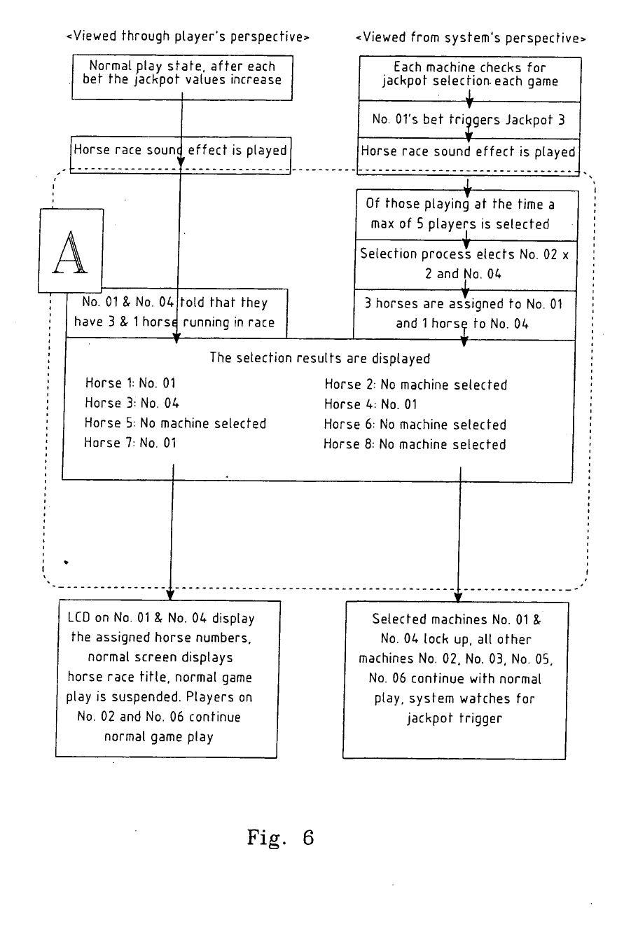

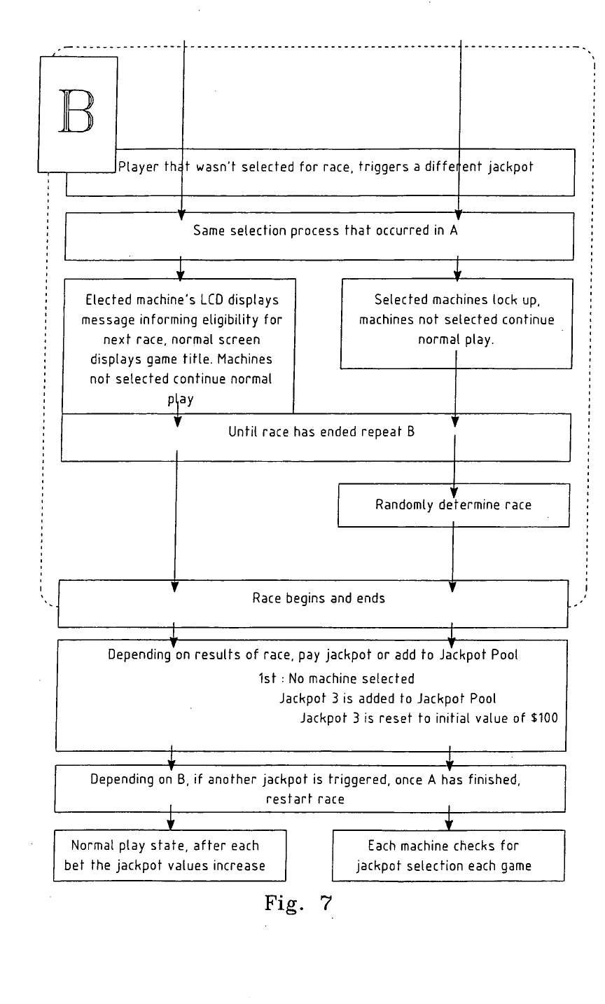

FIGS. 6 and 7 illustrate the above described example behaviour of FIG. 5 in flowchart form.

### EXAMPLE 2

Generalised Linked Progressive Mystery Jackpot with Jackpot Pool System applied to Specific Network Interconnection Systems

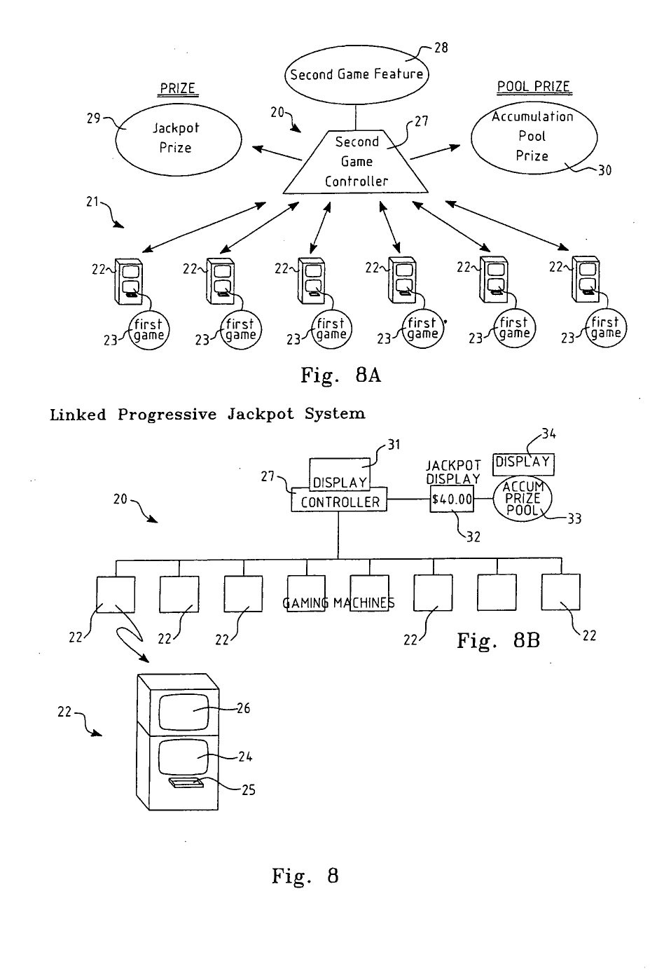

With reference to FIGS. 8, 9, 10 and 11 a second generalized embodiment of a linked jackpot controller 20 together with three examples of suitable networking interconnections between machines, the controller and various displays will be described.

Initially with reference to FIG. 8 there is illustrated a second generalized embodiment of a linked jackpot controller 20 and associated bank 21 of gaming machines 22.

With particular reference to FIG. 8A the basic concept involves each of the individual gaming machines 22 being enabled to play at least a first game 23. In effect the first game 23 is a machine game playable on each respective gaming machine 22 independent of the linked jackpot controller 20. With reference to the inset of FIG. 8 a typical gaming machine 22 includes an at least first display 24 which displays the results of first game 23 after the game is instigated by a player (not shown) typically via operation of one or more buttons, keys or the like on keyboard input panel 25. Most usually the at least first display 24 displays a simulation of a spinning reel based “poker” or similar symbol-based game. In many jurisdictions the probabilities of win and payout on the first game 23 are regulated.

With further reference to the inset of FIG. 8 each gaming machine 22 may include a second display 26 which may be arranged to display variable images under the control of an electronic controller. In one form the second display 26 can take the form of a CRT or like cathode ray tube based display. In alternative forms it can take the form of an LCD display. The advantage of such electronically image-manipulatable displays is that what is displayed on the display can be changed readily under the actions of an electronic controller which, in turn, is controlled by software.

Reverting to FIG. 8A the linked jackpot controller system 20 includes a second game controller 27 which controls the playing of and outcome of a second game feature 28.

The second game feature provides for an outcome in the form of a prize or jackpot prize 29 and also for an outcome in the form of a pool prize 30.

The pool prize 30 is an accumulation of prizes 29 which have been the subject of a second game feature 28, but have not been won or awarded to an eligible player playing one or more of the gaming machines 22 by second game controller 27.

In a particular form more than one prize 29 may be available at any one time. It can also be that those players not eligible for a current play of a second game feature 28 may continue to play their respective gaming machines 22 all the while being eligible to win others of prize 29 via a further second game feature 28 yet to be run.

In FIG. 8A the communication topology is such that each gaming machine 22 forming bank 21 communicates directly with second game controller 27. However, other topologies are possible as shown in FIG. 8B and as will be described in further detail below.

With particular reference to FIG. 8B a communication topology is shown wherein gaming machines 22 are linked into direct communication with each other as a bank 21 and also with second game controller 27. In this particular topology second game controller 27 communicates the progress of second game feature 28 on second game feature progress display 31. The currently available prize 29 is displayed in prize display or jackpot prize display 32 whilst the current value of the accumulation prize pool 33 is displayed on pool prize display 34. The current value of the accumulation prize pool 33 is, in effect, the current pool prize 30.

Similarly, the current value displayed on prize display 32 is the current prize or jackpot prize 29 available via a play of second game feature 28 under the control of second game controller 27.

An exemplary play of the linked jackpot controller system 20 illustrated in FIG. 8 wherein the second game feature takes the form of a horse race and wherein second display 26 on each gaming machine 22 takes the form of an LCD display in a “top box” portion of each machine 22 is as follows:

Exemplary Run of Second Game Feature—Horse Race

Players bet on normal game, percentage of turnover is transferred to jackpot controller

A random mystery jackpot is set to trigger between certain values, these values being in a range that results in the jackpot being triggered regularly

Once mystery jackpot has been triggered a second game feature starts

Jackpot controller randomly selects winning machine or machines

To be eligible for mystery jackpot, player(s) must participate in a second game (eg. Horse race)

Player(s) is randomly pre-selected a horse by the controller, race is displayed on large display or on LCD display in top box

If using LCD display the race could be run across a bank of machines

Player with the winning horse is entitled to mystery jackpot value($40.00)

The losing player(s) return to the normal game

After either a win or loss occurs the jackpot controller resets the mystery jackpot value to its minimum value

If no player has the winning horse, the jackpot is transferred to a Prize Pool, this Prize Pool is displayed on another display, players are eligible for this Prize Pool only if they have been randomly selected by the jackpot controller to participate in the mystery jackpot second game and have the randomly pre-selected winning horse.

When mystery jackpot is triggered again, and if a player with the pre-selected winning horse wins, that player wins both the mystery jackpot value and the amount of the Prize Pool, or if no winning horse was pre-selected the jackpot again gets transferred to the Prize Pool

After a win on the second game both the mystery jackpot and Prize Pool values are reset to their minimum values

Exemplary Communication Topologies

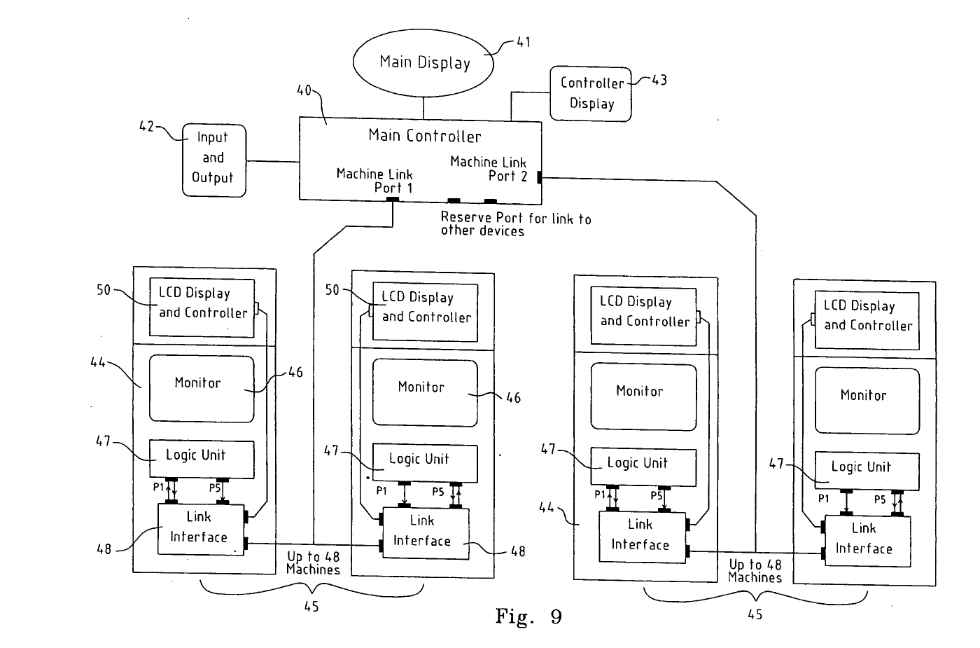

In conjunction with the description of FIG. 8 and with particular reference to each of FIGS. 9, 10 and 11, specific inter-machine and inter-controller topologies will now be described:

In this instance, in each of the topologies of FIGS. 9, 10 and 11, the second game controller takes the form of main controller 40. In a particular form main controller 40 can be implemented on a personal computer or like computing device and adapted to drive a main display 41 which can act as a second game feature progress display and can also act as a prize display and a pool prize display. The main controller 40 can be programmed or otherwise manipulated via input output unit 42 and controller display 43.

In the instance of each of FIGS. 9, 10, 11 each gaming machine 44 forming part of a bank 45 includes a monitor 46 acting as a first display for display of progress and results associated with a first game playable on each respective gaming machine 44. The first game is controlled by means of a machine logic unit 47. Typically the logic unit 47 will communicate with monitor 44 and will also communicate with a player by means of a keyboard such as keyboard 25 of FIG. 8. The logic unit 47 also communicates with the cash in and cash out systems of the gaming machine 44 including, for example, bill validator units and coin transport systems.

The logic unit 47 also communicates with a link interface 48. The link interface 48 is the intermediary for communication via communication line 49 with all machines 44 forming bank 45.

In the instance of the topology of FIG. 9 each link interface 48 is the only means of communication between each machine 44 and main controller 40 by way of communications line 49.

In the instance of FIG. 9 the link interface 48 is also utilized to communicate with a second display in the form of an LCD display and controller 50 mounted, in this instance, for viewing in each machine 44 above monitor 46 of each machine 44.

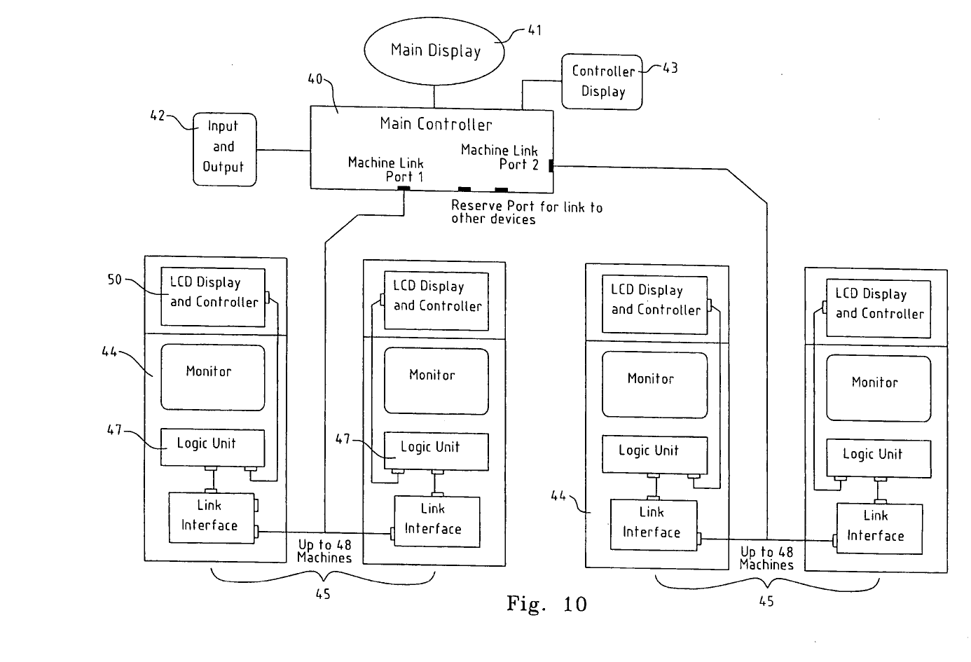

In the instance of FIG. 10 communication with the LCD display and controller 50 of each machine 44 is via each respective machine's logic unit 47.

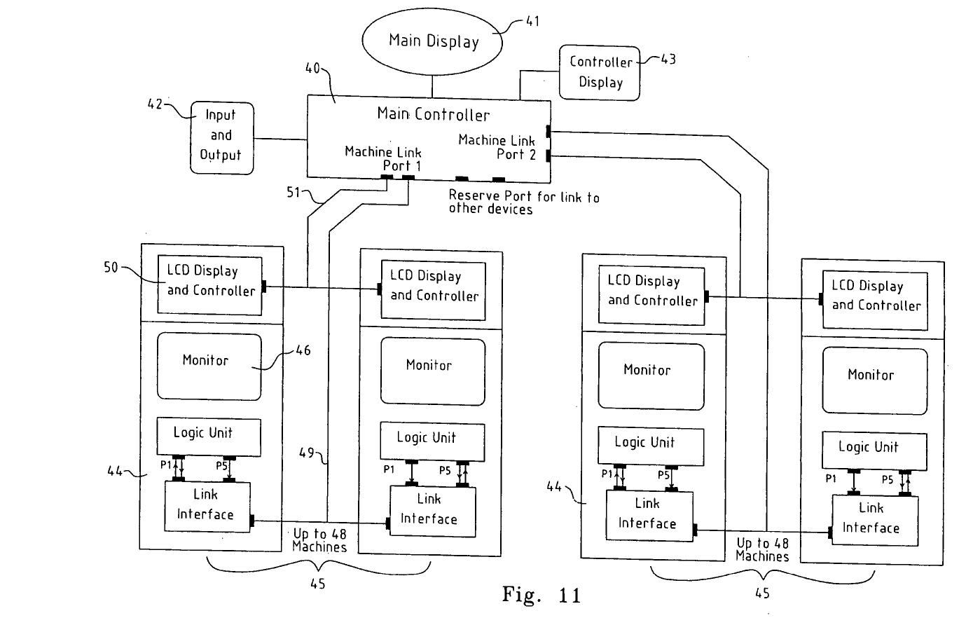

In the case of the topology of FIG. 11 communication and control of the LCD display and controller 50 of each machine is run directly from main controller 40 by means of second communications line 51 thereby providing fully independent control of the second display on each machine in the form of LCD display and controller 50 without the requirement to communicate via the link interface and logic units of each machine on communications line 49.

The above describes only some embodiments of the present invention and modifications, obvious to those skilled in the art, can be made thereto without departing from the scope and spirit of the present invention.

1. A jackpot controller including computing and display means linked to an array of gaming consoles, the consoles arranged to display selected first game features wherein randomized events are caused to award a prize if a predefined event occurs, the controller being characterized in that it is arranged to provide a second game feature which awards a jackpot; and wherein a pool increases incrementally by the current value of said jackpot whenever said jackpot is made available for winning by the second game feature but is not won.

2. The jackpot controller according to claim 1, wherein the jackpot controller includes a CPU, a memory device and input and output devices.

3. The jackpot controller according to claim 1, wherein the display means include a controller display screen, a jackpot display screen and a pool display screen.

4. The jackpot controller according to claim 1, wherein the controller is adapted to accept input data from the array of consoles and is adapted to output data to the consoles.

5. The jackpot controller according to claim 1, wherein the controller stores data generated by the progress of play on the linked gaming consoles.

6. The jackpot controller according to claim 5, wherein the data collected by the controller includes the following data objects:
(i) The elapsed time from program initiation or from the completion of the last second game feature whichever is the later.
(ii) The number and value of bets placed on each of the linked gaming consoles.

7. The jackpot controller according to claim 1, wherein the controller display screen is used to inform players at the consoles about the second game feature.

8. The jackpot controller according to claim 1, wherein the jackpot screen displays the type and amount of a prize comprising the jackpot.

9. The jackpot controller according to claim 1, wherein the pool screen indicates the current amount, if any, of an accrued pool prize.

10. The jackpot controller according to claim 1, wherein the second game feature is arranged to determine the winner of a jackpot or pool prize.

11. The jackpot controller according to claim 1, wherein the jackpot may take a value which is constant.

12. The jackpot controller according to claim 1, wherein the jackpot value may increase incrementally from a base value to a maximum value.

13. The jackpot controller according to claim 1, wherein a second game feature may be triggered to occur according to any one of the following events:
(i) A random time interval from a preceding second game feature, the time interval defined as lying between a minimum and a maximum value.
(ii) The value of a variable data object stored in the memory of the controller when this is equal to a pre-determined value.
(iii) The value of a variable calculated from the data objects stored in the memory of the controller according to an algorithm when the calculated value is equal to a pre-determined value.

14. The jackpot controller according to claim 1, wherein the controller is arranged to select a number of players from the linked consoles as being eligible to play in the second game feature when this is triggered.

15. The jackpot controller according to claim 14, wherein the selected eligible players have the option to elect to participate in said second game feature by indicating to the controller their willingness to participate in the second game feature.

16. The jackpot controller according to claim 14 wherein a player selected by said controller as eligible to play said second game feature is automatically included in the play of said second game feature.

17. The jackpot controller according to claim 1, wherein the second game feature is a virtual horse race and wherein eligible players may be allocated a virtual horse by the controller.

18. The jackpot controller according to claim 16, wherein the number of horses to run in the second game feature is always larger than the number of horses allocated to eligible players.

19. The jackpot controller according to claim 16, wherein the winning horse in the virtual horse race is randomly determined.

20. The jackpot controller according to claim 16, wherein if the winning horse in the race was allocated to a player, that player wins the jackpot prize and the pool prize.

21. A bank of gaming consoles in communication with the jackpot controller of claim 1.

22. A gaming console in communication with the jackpot controller of claim 1.

23. A gaming system for play by players playing a primary game on one or more gaming machines of a plurality of gaming machines; said plurality of gaming machines electronically linked into a bank of gaming machines; a secondary game controller in communication with each of said plurality of gaming machines forming said bank; said secondary game controller controlling a secondary game for which said players can be eligible to play; said secondary game awarding a jackpot; and wherein a pool increases incrementally by the current value of said jackpot whenever said jackpot is made available for winning by the second game feature but is not won.

24. The gaming system of claim 23 wherein said secondary game comprises a game viewable by all said players.

25. The gaming system of claim 23 wherein said secondary game awards both a prize and the contents of an accumulation prize pool if a play of said secondary game is won by an eligible player of at least one gaming machine on a play of said secondary game.

26. The gaming system of claim 23 wherein eligible players of said gaming machines for a play of said secondary game are selected by said secondary game controller.

27. The gaming system of claim 26 wherein a player can be selected more than once by said secondary game controller for a play of said secondary game.

28. The gaming system of claim 26 wherein a play of said secondary game is shown on a monitor associated with said secondary game controller.

29. The gaming system of claim 24 wherein a play of said secondary game is shown on a display associated with each gaming machine of said plurality of gaming machines.

30. The gaming system of claim 23 wherein a play of said secondary game is illustrated in animated form passing progressively from one to an adjacent one of said plurality of gaming machines.

31. In association with a bank of interconnected gaming machines, a secondary game feature which awards both a prize and the contents of an accumulation prize pool if a play of said secondary game feature is won by an eligible player of at least one gaming machine of said bank of interconnected gaming machines; and wherein the pool increases incrementally by the current value of the jackpot whenever the jackpot is made available for winning by the second game feature but is not won.

32. The secondary game feature of claim 31 wherein if said prize is not won on said play, then said prize is added to said accumulation prize pool.

33. The secondary game feature of claim 31 wherein eligibility of a player to participate in said secondary game feature is independent of the outcome of a primary game feature running on any one of said gaming machines.

34. The secondary game feature of claim 31 wherein said secondary game feature is run by a secondary game controller running independently of any one of said interconnected gaming machines.

35. The secondary game feature of claim 34 wherein said secondary game controller determines eligibility of a player to participate in said secondary game feature.
